(19) United States
(12) Patent Application Publication
(10) Pub. No.: US 2008/0075430 A1
(43) Pub. Date: Mar. 27, 2008

(54) Method for composing a personalized story

(76) Inventors: Catherine R. Bromley, American Fork, UT (US); Trisha Godfrey, American Fork, UT (US); Lori Cardon, Rexburg, ID (US)

Correspondence Address: DAVID R. MCKINNEY, P.C., P.O. BOX 1460, SANDY, UT, 84091, US

(21) Appl. No.: 11/901,705

(22) Filed: Sep. 18, 2007

Related U.S. Application Data
(60) Provisional application No. 60/845,315, filed on Sep. 18, 2006.

(51) Int. Cl. H04N 5/91

(52) U.S. Cl. 386/95; 386/E05.001

(57) ABSTRACT

A method for producing a personalized story includes the steps of obtaining information from a person regarding a personal event or memory, compiling the information into a complete story, recording the story in a tangible recording medium, and selling recording medium containing the story to the person.

### PRIORITY CLAIM

The present application claims priority from U.S. Provisional Patent Application Ser. No. 60/845,315, filed on Sep. 18, 2006, and entitled METHOD FOR COMPOSING A PERSONALIZED STORY.

### BACKGROUND

1. Field of the Invention

The present invention relates generally to the creation of a personalized story. More particularly, the present invention relates to a method for using information provided by a customer to compose and produce on-demand a finished publication for the customer.

2. Related Art

The scrapbooking industry has grown tremendously in recent years, fueled in part by an increasing desire among the general public to keep better and more meaningful records of their lives and activities, and by the increased ease of compiling and producing creative and interesting journals, scrapbooks and the like using modern digital photography and specialized computer software. Consequently, scrapbooking stores have become more popular, confirming that there are many people who want to create long-lasting records of memories and events. Unfortunately, scrapbooking still generally involves individuals producing individual photographs, mementos, etc. and affixing them in a scrapbook. Some of these books allow pages to be inserted or removed, while others are permanently bound and simply provide blank pages on which the individual attaches items.

The creative and short-run publishing industry is also a fast growing industry, made possible in part by computer controlled short-run printing and book binding machines that are commercially available and increasingly inexpensive. Unfortunately, there are relatively few short-run publishing companies that offer same-day turnaround time. Usually there is at least a one week to 10-day waiting period.

### SUMMARY

It has been recognized that it would be advantageous to develop an entity that combines the benefits of on-demand publishing with the creative recording of memories and personal stories.

It has also been recognized that it would be advantageous to have a method for providing a hands-on retail service that allows people to publish their own life stories in a creative way.

In accordance with one embodiment thereof, the present invention provides a method for producing a personalized story, comprising the steps of obtaining information from a person regarding a personal event or memory, compiling the information into a complete story, affixing the story in a tangible recording medium, and selling the recording medium containing the story to the person.

In accordance with another aspect thereof, the invention provides a method for producing a book containing a personalized story, comprising the steps of obtaining information from a person regarding a personal event or memory at a retail location, compiling the information into a complete story in electronic form, adding illustrations to the story, printing the story on pages and binding the printed pages into a finished book, and selling the book to the person.

In accordance with another aspect thereof, the invention provides a method for producing a personalized story, comprising the steps of obtaining information from a person regarding a personal event or memory, compiling the information into a complete story in electronic form, adding electronic illustrations to the story, affixing the story in a multi-media recording medium, and selling the multi-media recording medium containing the recording of the story to the person.

In accordance with yet another aspect thereof, the invention provides a method for producing a personalized story, comprising the steps of recording a voice of a person reading or telling a story, and placing a recording medium containing the story read by the person into a book containing the story.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a flow chart showing the steps in one embodiment of a method for composing a personalized story in accordance with the present disclosure, wherein the story is printed and bound for the customer;

FIG. 2 is a flow chart showing the steps in another embodiment of a method for composing a personalized story; and

FIG. 3 is a flow chart showing the steps in yet another embodiment of a method for composing a personalized story, wherein a recording is made of a person relating a story, and the recording is placed with the story.

### DETAILED DESCRIPTION

Reference will now be made to exemplary embodiments of the invention illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The inventors have recognized that while there are numerous genealogical programs and scrapbook facilities available for assisting individuals in preserving their memories, and there are many short-run publishing companies, there do not appear to be any entities that combine the benefits of on-demand publishing with the creative recording of memories and personal stories. Recognizing the great potential in the fields of creative publishing and recording of life experiences, the inventors have developed a method for providing a hands-on retail service that allows people to publish their own life stories in a creative way. The objective of the method is to allow individuals who have always wanted to write a book to have that opportunity. Customers will be able to walk into an interactive and entertaining retail store setting, and see the creation of a book from beginning to end. The book will be based upon information and events from the customer's own life; their own memories will be brought to life in a hard-bound keepsake book.

The retail store setting is designed to be pleasant and exhibit a creative atmosphere, both to the eye and to the mind. The store floor plan will be well-organized and tastefully decorated, with sufficient working stations and personnel. High-quality samples of advertised products will be available to allow customers to perceive what they will be creating.

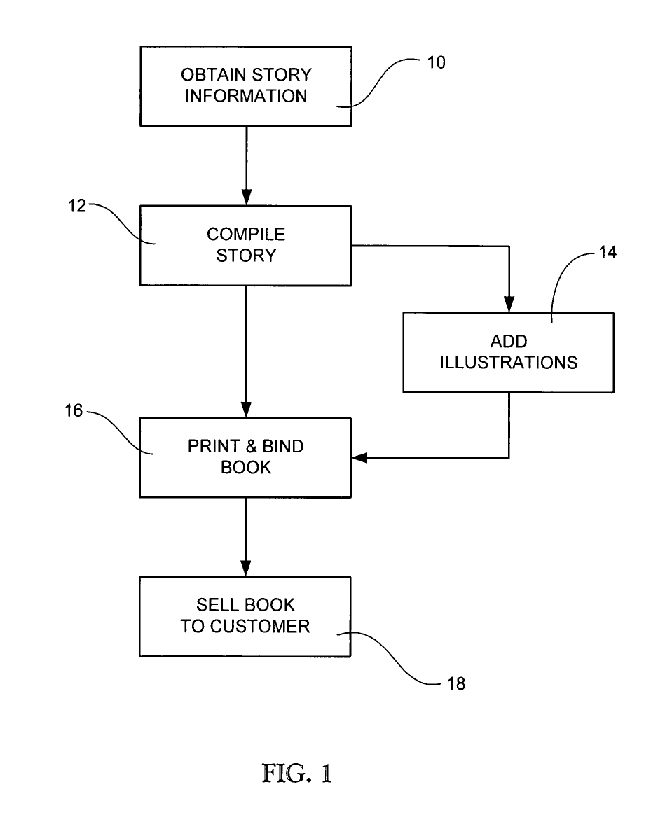

Referring to FIG. 1, in one embodiment of the method, the customer can enter the retail store, sit at a comfortably-arranged computer terminal, and compose a story. The story can be about a single event or memory, or it can include multiple events or memories. Compiling and composing the story generally requires first obtaining story information (step 10) and compiling the information into a story (step 12). This can be done in several different ways. In one approach, the computer at which the customers works can be provided with interactive software designed for preparing personal stories. The interactive software program can prompt the customer to answer a variety of questions regarding the specific event or memory. For example, a grandmother might like to share her memory of her first home, wedding day or her family's first automobile. The computer can ask questions about this memory, and the answers will form the basis of the final story. Once the basic questions are answered (i.e. the story information has been obtained at step 10), the software can compose those answers into a complete story, which can then be reviewed and edited by the customer. Where the computer system initially composes the story and the customer edits the story, both of these actions are to be viewed as part of step 12.

As an alternative, the steps of obtaining story information (step 10) and compiling the story (step 12) can comprise the customer composing the story in its entirety. For example, the customer can compose the story using the computer terminal provided by the retail establishment, or the customer can compose the story elsewhere and bring a copy (electronic or otherwise) of the completed story to the retail location, where this completed story can be used in the remaining steps in various embodiments of the method disclosed herein.

After the story is written, the customer can then have illustrations and pictures added to the story (step 14). These can be the customer's own personal photographs (e.g. digital photographs), or they can be illustrations from a catalog of stock illustrations provided by the retail establishment, or they can be illustrations that are custom-created by graphic artists and designers employed by the store, or they can be a mix of all these or illustrations from other sources.

Once the story is complete and provided with illustrations, if desired, the completed story in electronic form can be sent to a desktop printing system, where it is printed, and then the book is bound right in the store (step 16). Short-run printing and book binding machines are commercially available and make this custom book production possible. These machines are widely used in the custom publishing industry, and allow low start-up costs and efficient operation. Because printing is done onsite, the store can also become an educational site, where children can learn how printing and binding facilities work. The printing and binding machines can be displayed behind a protected barrier in full view of customers, for example. The book can be bound with an attractive hard cover (or any other desired binding) and the customer can take the book home with them (step 18).

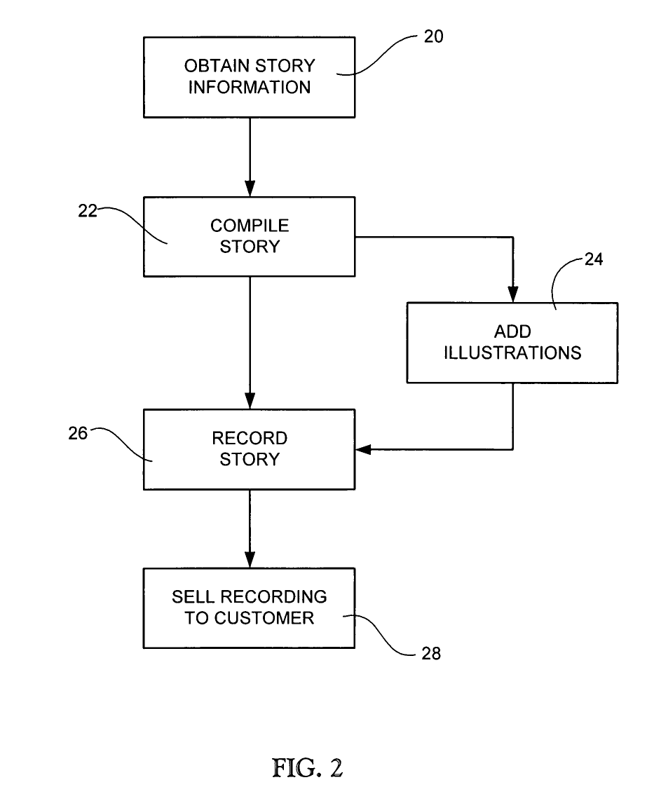

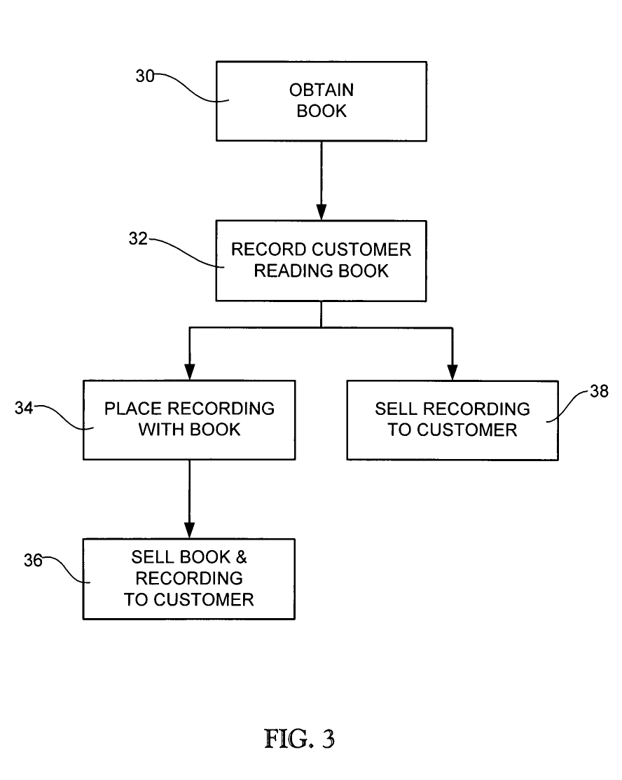

In an alternative embodiment, illustrated in FIG. 2, once the story information is obtained (step 20), compiled into a story (step 22), and provided with desired illustrations (step 24), the story can then be recorded in some fixed medium (step 26). This recording can be on any type of suitable electronic medium, such as floppy disk, DVD, CD/ROM, etc. This can allow the recorded work to include multi-media aspects, such as audio and video clips that, for example, form part of the story or record. Similarly, an audio recording (on any audio recording medium—e.g. MP3, CD, etc.) can also be provided along with a bound book, whether the book is a personalized story as described above, or some other book. The audio recording can provide a voice recording of a person reading the story, as described below in connection with FIG. 3. Like the illustrations mentioned above, these audio and video clips can be provided by the customer, or can come from a catalog of stock video or audio clips (including animation), or they can be custom-created by the retail establishment, or they can be a mix of items from any of these or other sources. The multi-media embodiment can parallel or add to the contents of a bound personalized story, and can be placed in the back of that book, or can stand alone. When the multi-media book is completed, the customer leaves the store with the completed CD or DVD (step 28).

Another embodiment of a method for composing a personalized story is shown in FIG. 3. In this embodiment a parent, grandparent or other person can have an audio or video recording of himself/herself reading a storybook. The customer or the retail establishment first obtains the book (step 30). Then the customer is recorded reading the book (step 32). The recording medium (e.g. CD, flash memory card, MP3 device, etc) can then be placed with the book (step 34), and sold to the customer (step 36). Placing the recording with the book can involve placing the recording medium in a pocket or other holder in the back of the bound book, or the recording can be included on the same recording medium (e.g. CD, DVD, etc.) on which the story is recorded, if in some other format. Alternatively, the audio or video recording of the person reading the story can be sold directly to the customer (step 38).

The personalized story can be essentially anything desired by the customer. In one embodiment, the personalized story is along the lines of a bedtime story, based on a personal memory, which can be presented to grandchildren, other family members and friends. This personalized story thus provides a new way of recording and preserving life events and memories.

The retail store can also provide other services, such as on-demand book binding services for the general public. Customers may bring items printed elsewhere to be bound in covers of their choice. The retail establishment can also provide audio and video recordings for customers, whether or not associated with the production of a personalized story.

The method thus offers a hands-on service to assist people in publishing their own life stories in a hard-bound keepsake book. One aspect of the method is to produce and publish bedtime stories, based on personal memories of parents, grandparents, extended family members and friends. The customer will be able to see the creation of a unique book from beginning to end. Customers will come in with a memory and leave with a professionally published book or multi-media device through which that memory can live on in the lives of their posterity.

By way of example, and without limitation, the invention can be described as a method for producing a personalized story, comprising the steps of obtaining information from a person regarding a personal event or memory, compiling the information into a complete story, affixing the story in a tangible recording medium, and selling the recording medium containing the story to the person.

As another example, the invention can be described as a method for producing a book containing a personalized story, comprising the steps of obtaining information from a person regarding a personal event or memory at a retail location, compiling the information into a complete story in electronic form, adding illustrations to the story, printing the story on pages and binding the printed pages into a finished book, and selling the book to the person.

As another example, the invention can be described as a method for producing a personalized story, comprising the steps of obtaining information from a person regarding a personal event or memory, compiling the information into a complete story in electronic form, adding electronic illustrations to the story, affixing the story in a multi-media recording medium, and selling the multi-media recording medium containing the recording of the story to the person.

As yet another example, the invention can be described as a method for producing a personalized story, comprising the steps of recording a voice of a person reading or telling a story, and placing a recording medium containing the story read by the person into a book containing the story.

It is to be understood that the above-referenced arrangements are only illustrative of the application of the principles of the present invention in one or more particular applications. It will be apparent to those of ordinary skill in the art that numerous modifications and alternative arrangements in form, usage and details of implementation can be devised without the exercise of inventive faculty, and without departing from the principles, concepts, and scope of the invention as disclosed herein. Accordingly, it is not intended that the invention be limited, except as set forth in the claims.

What is claimed is:

1. A method for producing a personalized story, comprising the steps of:
obtaining information from a person regarding a personal event or memory;
compiling the information into a complete story;
recording the story in a tangible recording medium; and
selling the recording medium containing the story to the person.

2. A method in accordance with claim 1, wherein the step of obtaining information from the person comprises obtaining answers to questions via a questionnaire administered by a computer system.

3. A method in accordance with claim 2, wherein the step of compiling the information into a complete story comprises:
electronic composition of the story via composition software associated with the computer system; and
editing of the story performed by the person.

4. A method in accordance with claim 1, wherein the steps of obtaining information and compiling the information into a story are performed entirely by the person.

5. A method in accordance with claim 1, wherein the steps of recording the story and selling the recording medium are performed at a retail location.

6. A method in accordance with claim 1, further comprising the steps of:
adding illustrations to the story; and
recording the illustrations with the story in the tangible recording medium.

7. A method in accordance with claim 1, further comprising the step of adding at least one of an audio clip and a video clip to the recorded story.

8. A method in accordance with claim 8, wherein the step of compiling the information into a complete story comprises producing a multi-media recording including text and other media.

9. A method in accordance with claim 1, wherein the recording medium is selected from the group consisting of CD, DVD, floppy disk, flash memory device, and an MP3 device.

10. A method in accordance with claim 1, wherein the step of recording the story in a tangible recording medium comprises printing the story on pages and binding the printed pages into a book.

11. A method for producing a book containing a personalized story, comprising the steps of:
obtaining story information from a customer and compiling the information into a complete story at a retail location;
adding illustrations to the story;
printing the story on pages and binding the printed pages into a book; and
providing the book to the customer.

12. A method in accordance with claim 11, wherein the step of obtaining information from the customer comprises obtaining answers to questions via a computer system operated by the customer at the retail location.

13. A method in accordance with claim 12, wherein the step of compiling the information into a complete story comprises:
electronically composing the story via composition software associated with the computer system; and
editing the story.

14. A method in accordance with claim 11, further comprising the steps of producing a multi-media recording relating to the story and selling the multi-media recording with the book.

15. A method in accordance with claim 14, wherein the multi-media recording includes at least one of an audio clip and a video clip related to the story.

16. A method in accordance with claim 11, wherein the step of obtaining story information from the customer and compiling the information into a complete story at the retail location comprises obtaining a substantially complete story from the customer at the retail location.

17. A method for producing a personalized story, comprising the steps of:
recording a person relating a story; and
providing a recording of the person relating the story with recording medium containing the story.

18. A method in accordance with claim 17, wherein the step of recording a person relating a story comprises recording the voice of the person reading the story from print media.

19. A method in accordance with claim 18, wherein the step of providing the recording of the person relating the story comprises physically placing a recording medium containing the recording with the physical volume containing the printed story.

20. A method in accordance with claim 11, wherein the recording medium comprises electronic recording media, and the step of providing the recording of the person relating the story comprises saving the recording of the person relating the story upon the electronic media containing the story.
